(19) United States
(12) Patent Application Publication
(10) Pub. No.: US 2022/0295379 A1
(43) Pub. Date: Sep. 15, 2022

(54) INFORMATION PROCESSING DEVICE, INFORMATION PROCESSING METHOD, AND NON-TRANSITORY COMPUTER READABLE MEDIUM

(71) Applicant: FUJIFILM Business Innovation Corp., Tokyo (JP)

(72) Inventors: Makoto TORIYAMA, Kanagawa (JP); Kengo TOKUCHI, Kanagawa (JP); Kosuke AOKI, Kanagawa (JP); Kosuke TOMOKUNI, Kanagawa (JP); Seiichiro HIRATSUKA, Kanagawa (JP)

(73) Assignee: FUJIFILM Business Innovation Corp., Tokyo (JP)

(21) Appl. No.: 17/374,786

(22) Filed: Jul. 13, 2021

(30) Foreign Application Priority Data
Mar. 10, 2021 (JP) 2021-038248

(51) Int. Cl. H04W 48/04; H04W 4/029; H04W 76/38

(52) U.S. Cl. CPC H04W 48/04; H04W 4/029; H04W 76/38; G06F 9/442

(57) ABSTRACT

An information processing device includes a processor configured to control a connection to a communication destination and use of a data storage location in the information processing device itself on a basis of a position of the information processing device.

### CROSS-REFERENCE TO RELATED APPLICATIONS

This application is based on and claims priority under 35 USC 119 from Japanese Patent Application No. 2021-038248 filed Mar. 10, 2021.

### BACKGROUND

### (i) Technical Field

The present disclosure relates to an information processing device, an information processing method, and a non-transitory computer readable medium.

### (ii) Related Art

Technology that changes a destination of communication according to the position of a device is known.

Japanese Unexamined Patent Application Publication No. 2007-110601 describes a system for changing a communication medium without having a personal computer not equipped with a hard disk device perform a reconnection operation.

Japanese Unexamined Patent Application Publication No. 2015-133587 describes a server that acquires information related to at least one of a communication quality of a terminal and a terminal state, and on the basis of the acquired information, switches a peer with which to transmit or receive communication data from the terminal to a different terminal.

Japanese Unexamined Patent Application Publication No. 2009-252108 describes a system that switches a destination sync client server according to a usage scenario.

### SUMMARY

Aspects of non-limiting embodiments of the present disclosure relate to supporting both connecting to a communication destination and using a data storage location in an information processing device according to the position of the information processing device.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing device includes a processor configured to control a connection to a communication destination and use of a data storage location in the information processing device itself on a basis of a position of the information processing device.

### BRIEF DESCRIPTION OF THE DRAWINGS

An exemplary embodiment of the present disclosure will be described in detail based on the following FIGS., wherein:

FIG. 1 is a block diagram illustrating a configuration of an information processing system according to an exemplary embodiment;

FIG. 2 is a block diagram illustrating a configuration of a server;

FIG. 3 is a block diagram illustrating a configuration of a terminal device;

FIG. 4 is a flowchart illustrating a flow of processes when starting up the terminal device;

FIG. 5 is a flowchart illustrating a flow of processes when starting use;

FIG. 6 is a flowchart illustrating a flow of processes when moving;

FIG. 7 is a diagram illustrating a settings screen;

FIG. 8 is a diagram illustrating a settings screen;

FIG. 9 is a diagram illustrating a settings screen;

FIG. 10 is a diagram illustrating a settings screen;

FIG. 11 is a diagram illustrating positions;

FIG. 12 is a diagram illustrating positions;

FIG. 13 is a diagram illustrating a settings screen;

FIG. 14 is a diagram illustrating a settings screen;

FIG. 15 is a diagram illustrating a terminal device;

FIG. 16 is a diagram illustrating a settings screen;

FIG. 17 is a diagram illustrating a settings screen;

FIG. 18 is a diagram illustrating a settings screen; and

FIG. 19 is a diagram illustrating a settings screen.

### DETAILED DESCRIPTION

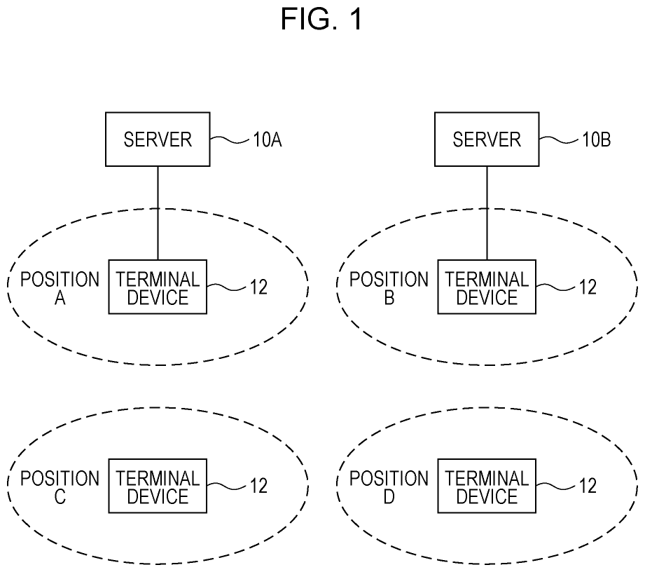

An information processing system according to an exemplary embodiment will be described with reference to FIG. 1. FIG. 1 illustrates an example of the configuration of the information processing system according to the exemplary embodiment.

The information processing system according to the exemplary embodiment includes multiple servers (for example, servers 10A and 10B) and one or multiple terminal devices 12, for example. The number of servers illustrated in FIG. 1 is merely an example, and three or more servers may also be included in the information processing system.

Each of the servers 10A and 10B and each terminal device 12 has a function of communicating with other devices. The communication may be wired communication using a cable, or wireless communication. In other words, each device may transmit and receive information through a physical connection to other devices using a cable, or transmit and receive information through wireless communication. The wireless communication is a technology such as short-range wireless communication or Wi-Fi (registered trademark) may be used, for example. The short-range wireless communication is a technology such as Bluetooth (registered trademark), radio-frequency identifier (RFID), or NFC. For example, each device may communicate with other devices through a communication channel such as a local area network (LAN) or the Internet.

The servers 10A and 10B have a function of providing information to users, processing information, and providing processing results to users in response to requests from users. For example, each of the servers 10A and 10B is a sync client server, a file server, a backup server, a web server, or an email server. The servers 10A and 10B may also include functions other than the above. The servers 10A and 10B may be physically different devices or a single physical device.

Each terminal device 12 is a personal computer (hereinafter referred to as a “PC”), a tablet PC, a smartphone, a wearable device (such as augmented reality (AR) glasses, virtual reality (VR) glasses, mixed reality (MR) glasses, or a bearable device), or a mobile phone, for example.

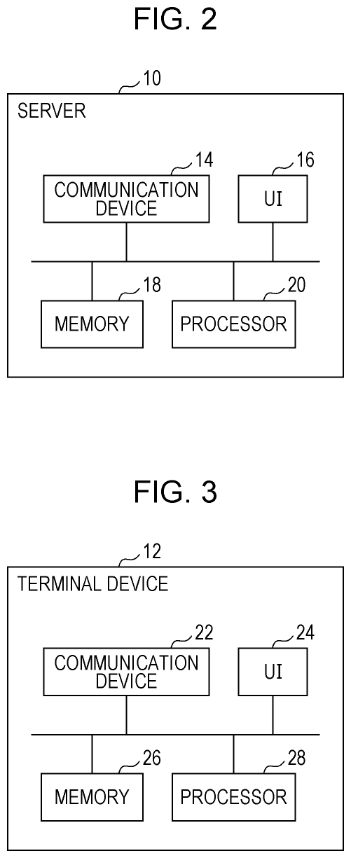

Hereinafter, FIG. 2 will be referenced to describe a hardware configuration of the servers 10A and 10B. FIG. 2 illustrates an example of a hardware configuration of the servers 10A and 10B.

For example, each of the servers 10A and 10B includes a communication device 14, a UI 16, a memory 18, and a processor 20.

The communication device 14 is a communication interface including components such as a communication chip and a communication circuit, and has a function of transmitting information to another device and a function of receiving information from another device. The communication device 14 may have a wireless communication function, and may also have a wired communication function. The communication device 14 may communicate with another device by using short-range wireless communication for example, or communicate with another device through a communication channel such as a LAN or the Internet.

The UI 16 is a user interface, and includes at least one of a display or an input device. The display is a liquid crystal display (LCD), an electroluminescence (OLED) display, or the like. The input device is a device such as a keyboard, a mouse, input keys, or a control panel. The UI 16 may also be a UI such as a touch panel combining a display with an input device. The UI 16 may also include a microphone and a speaker.

The memory 18 is a device that establishes one or multiple storage areas that store data. For example, the memory 18 is a hard disk drive (HDD), a solid-state drive (SSD), any of various types of memory (such as RAM, DRAM, or ROM, for example), another type of storage device (such as an optical disc, for example), or a combination of the above. One or multiple memories 18 are included in each server 10.

The processor 20 is configured to control the operation of each unit of each server 10. The processor 20 may also include a memory.

Hereinafter, FIG. 3 will be referenced to describe a hardware configuration of each terminal device 12. FIG. 3 illustrates an example of the hardware configuration of each terminal device 12.

Each terminal device 12 includes a communication device 22, a UI 24, a memory 26, and a processor 28, for example.

The communication device 22 is a communication interface including components such as a communication chip and a communication circuit, and has a function of transmitting information to another device and a function of receiving information transmitted from another device. The communication device 22 may have a wireless communication function, and may also have a wired communication function. The communication device 22 may communicate with another device by using short-range wireless communication for example, or communicate with another device through a communication channel such as a LAN or the Internet.

The UI 24 is a user interface, and includes at least one of a display or an input device. The display is a liquid crystal display (LCD), an electroluminescence (OLED) display, or the like. The input device is a device such as a keyboard, a mouse, input keys, or a control panel. The UI 24 may also be a UI such as a touch panel combining a display with an input device. The UI 24 may also include a microphone and a speaker.

The memory 26 is a device that establishes one or multiple storage areas that store data. For example, the memory 26 is a hard disk drive (HDD), a solid-state drive (SSD), any of various types of memory (such as RAM, DRAM, or ROM, for example), another type of storage device (such as an optical disc, for example), or a combination of the above. One or multiple memories 26 are included in each terminal device 12.

The processor 28 is configured to control the operation of each component of each terminal device 12. The processor 28 may also include a memory.

In the exemplary embodiment, the processor 28 of each terminal device 12 controls the connection to a communication destination and the use of a data storage location in each terminal device 12 itself.

The communication destinations are the servers 10A and 10B. The data storage location in each terminal device 12 is the memory 26 of the terminal device 12. The storage location may also be a folder created in the memory 26. For example, the processor 28 of each terminal device 12 acquires position information about the terminal device 12 itself by using a technology such as the Global Positioning System (GPS). Obviously, the processor 28 of each terminal device 12 may also acquire position information about the terminal device 12 by a method other than GPS.

The processor 28 of each terminal device 12 changes the communication destination according to the position of the terminal device 12 itself. For example, the processor 28 of each terminal device 12 connects to a communication destination corresponding to the position of the terminal device 12 itself, and restricts the use of a storage location in the terminal device 12. Restricting the use of a storage location may be, for example, prohibiting the use of all or part of a storage location, prohibiting the use of all or part of a storage location associated with accounts other than a specific account, or prohibiting the use of all or part of a storage location at times outside a specific time period.

In the case where the terminal device 12 exists at a specific position, the processor 28 of the terminal device 12 does not have to connect to a communication destination corresponding to the position of the terminal device 12 itself and restrict the use of a storage location in the terminal device 12. The specific position is preset by an administrator or a user, for example.

In the case where the terminal device 12 exists at a specific position, the processor 28 of the terminal device 12 may prohibit the use of the terminal device 12. Prohibiting the use of the terminal device 12 may be, for example, prohibiting the startup of the terminal device l2itself, prohibiting the launching of a program (such as an operating system (OS) or application software, for example) installed in the terminal device 12, or prohibiting the use of a program installed in the terminal device 12.

The processor 28 of each terminal device 12 may also change which programs (such as an OS and application software, for example) are usable in the terminal device 12 according to the position of the terminal device 12. For example, the processor 28 of each terminal device 12 may allow a user to use a program corresponding to the position of the terminal device 12.

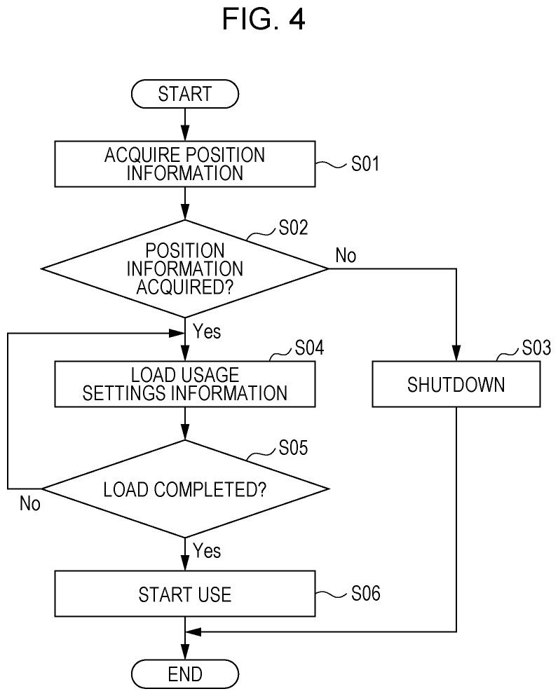

Hereinafter, FIGS. 4, 5, and 6 will be referenced to describe an overview of processes by the processor 28 of each terminal device 12.

FIG. 4 will be referenced to describe processes when starting up each terminal device 12. FIG. 4 is a flowchart illustrating a flow of the processes.

When the terminal device 12 is powered on, the processor 28 of the terminal device 12 uses a technology such as GPS to acquire position information about the terminal device 12 itself (S01).

In the case where the processor 28 of the terminal device 12 does not acquire position information about the terminal device 12 (S02, No), the processor 28 of the terminal device 12 shuts down the terminal device 12 (S03). Shutting down the terminal device 12 refers to powering off the terminal device 12, logging out a user from the terminal device 12, or putting the power state of the terminal device 12 into a sleep mode.

In the case where the processor 28 of the terminal device 12 acquires position about the terminal device 12 itself (S02, Yes), usage settings information is loaded (S04). The usage settings information is information indicating settings related to a destination, a storage location, and program use, and includes information (for example, an address such as a URL) indicating a destination corresponding to the position of the terminal device 12, information indicating whether the use of a storage location in the terminal device 12 is allowed or not, and information indicating which programs are allowed for use in correspondence with the position of the terminal device 12, for example. The usage settings information may also include information indicating settings related to the use of other resources. The usage settings information is stored in the memory 26 of the terminal device 12, for example. The usage settings information may also be stored in a device other than the terminal device 12 (such as a server, for example).

The processor 28 of the terminal device 12 stands by (S05, No) until the loading of the usage settings information is completed, and when the loading of the usage settings information is completed (S05, Yes), the processor 28 of the terminal device 12 starts using a connection, a storage location, or a program according to the settings indicated by the usage settings information (SO6).

Note that in the case where position information about the terminal device 12 is not acquired in step S01, the processor 28 of the terminal device 12 may also allow the user to use the terminal device 12 without shutting down the terminal device 12. For example, the terminal device 12 of the terminal device 12 may allow the user to use functions other than the functions indicated by the settings, without allowing use according to the settings indicating by the usage settings information.

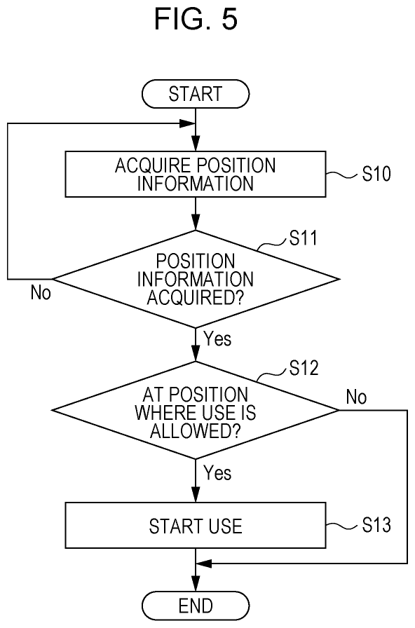

FIG. 5 will be referenced to describe the flow of processes when starting the use of a destination, a storage location, or a program. FIG. 5 is a flowchart illustrating a flow of the processes.

The processor 28 of the terminal device 12 uses a technology such as GPS to acquire position information about the terminal device 12 itself (S10).

The processor 28 of the terminal device 12 stands by (S11, No) until position information about the terminal device 12 is acquired, and when position information about the terminal device 12 is acquired (S11, Yes), the processor 28 of the terminal device 12 determines whether or not the position of the terminal device 12 is included among positions where the use of a destination, a storage location, or a program is allowed (S12).

In the case where the position of the terminal device 12 is not included among the positions where the use of a destination, a storage location, or a program is allowed (S12, No), the process ends. In this case, the use of the connection, storage location, or program is not allowed.

In the case where the position of the terminal device 12 is included among the positions where the use of a destination, a storage location, or a program is allowed (S12, Yes), the processor 28 of the terminal device 12 allows the user to use the destination, the storage location, or the program (S13).

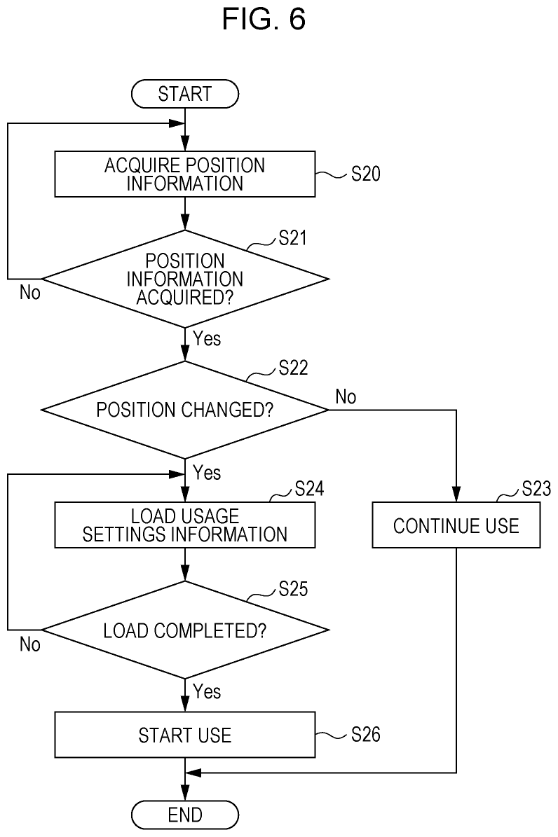

FIG. 6 will be referenced to describe a flow of processes when moving. FIG. 6 is a flowchart illustrating a flow of the processes.

The processor 28 of the terminal device 12 uses a technology such as GPS to acquire position information about the terminal device 12 itself (S20).

The processor 28 of the terminal device 12 stands by (S21, No) until position information about the terminal device 12 is acquired, and when position information about the terminal device 12 is acquired (S21, Yes), the processor 28 of the terminal device 12 determines whether or not the position of the terminal device 12 has changed (S22).

In the case where the position of the terminal device 12 has not changed (S22, No), the processor 28 of the terminal device 12 allows the user to use a destination, a storage location, or a program (S23).

In the case where the position of the terminal device 12 has changed (S22, Yes), the processor 28 of the terminal device 12 loads usage settings information (S24).

The processor 28 of the terminal device 12 stands by (S25, No) until the loading of the usage settings information is completed, and when the loading of the usage settings information is completed (S25, Yes), the processor 28 of the terminal device 12 starts using a connection, a storage location, or a program according to the settings indicated by the usage settings information (S26).

Hereinafter, FIG. 1 will be referenced to describe processes according to the exemplary embodiment in further detail.

In FIG. 1, positions A, B, C, and D are illustrated. In the example illustrated in FIG. 1, the positions A, B, C, and D are different positions. The position A is a position corresponding to the server 10A, and the position B is a position corresponding to the server 10B. In other words, the destination corresponding to the position A is the server 10A, and the destination corresponding to the position B is the server 10B. To put it another way, the server 10A is the destination for the terminal device(s) 12 existing at the position A, while the server 10B is the destination for the terminal device(s) 12 existing at the position B. For example, the server 10A is a device such as a sync client server or a backup server for a Company A, while the server 10B is a device such as a sync client server or a backup server for a Company B. Servers are not associated with the positions C and D. In other words, destinations corresponding to the positions C and D do not exist.

(Process in Case where Terminal Device 12 Exists at Position A)

In the case where the terminal device 12 exists at the position A, the processor 28 of the terminal device 12 connects to the server 10A. For example, the processor 28 of the terminal device 12 communicates by using the server 10A as a sync client server. Additionally, the processor 28 of the terminal device 12 may also use the server 10A as a backup server and transmit data to the server 10A to cause the data to be stored in the server 10A, or acquire data stored in the server 10A. In the case where the terminal device 12 exists at the position A, the processor 28 of the terminal device 12 does not connect to the server 10B.

Also, in the case where the terminal device 12 exists at the position A, the use of a storage location in the terminal device 12 (for example, the memory 26 or a folder created in the memory 26) is prohibited. In other words, the use of a local folder in the terminal device 12 is prohibited.

Also, in the case where the terminal device 12 exists at the position A, the use of a program corresponding to the position A (for example, an OS or application software) is allowed, and the use of data corresponding to the position A is allowed. For example, the use of a program for the Company A and data for the Company A is allowed. The program for the Company A and the data for the Company A are associated with position information indicating the position A and stored in the memory 26 of the terminal device 12 or in the memory 18 of the server 10A. In the case where the terminal device 12 exists at the position A, the use of a program corresponding to the position B and the use of data corresponding to the position B are prohibited. The use of the user□s own programs and data (for example, programs and data for private use) may be allowed.

(Process in Case where Terminal Device 12 Exists at Position B)

In the case where the terminal device 12 exists at the position B, the processor 28 of the terminal device 12 connects to the server 10B. For example, the processor 28 of the terminal device 12 communicates by using the server 10B as a sync client server. Additionally, the processor 28 of the terminal device 12 may also use the server 10B as a backup server and transmit data to the server 10B to cause the data to be stored in the server 10B, or acquire data stored in the server 10B. In the case where the terminal device 12 exists at the position B, the processor 28 of the terminal device 12 does not connect to the server 10A.

Also, in the case where the terminal device 12 exists at the position B, the use of a storage location in the terminal device 12 (for example, the memory 26 or a folder created in the memory 26) is prohibited. In other words, the use of a local folder in the terminal device 12 is prohibited.

Also, in the case where the terminal device 12 exists at the position B, the use of a program corresponding to the position B (for example, an OS or application software) is allowed, and the use of data corresponding to the position B is allowed. For example, the use of a program for the Company B and data for the Company B is allowed. The program for the Company B and the data for the Company B are associated with position information indicating the position B and stored in the memory 26 of the terminal device 12 or in the memory 18 of the server 10A. In the case where the terminal device 12 exists at the position B, the use of a program corresponding to the position A and the use of data corresponding to the position A are prohibited. The use of the user□s own programs and data (for example, programs and data for private use) may be allowed.

(Process in Case where Terminal Device 12 Exists at Position C)

In the case where the terminal device 12 exists at the position C, the use of the servers 10A and 10B is prohibited, and the processor 28 of the terminal device 12 does not connect to the server 10A or 10B.

Also, in the case where the terminal device 12 exists at the position C, the use of a storage location in the terminal device 12 (for example, the memory 26 or a folder created in the memory 26) is allowed. In other words, the use of a local folder in the terminal device 12 is allowed.

Also, in the case where the terminal device 12 exists at the position C, the use of a program corresponding to the position A, the use of data corresponding to the position A, the use of a program corresponding to the position B, and the use of data corresponding to the position B are prohibited. On the other hand, the use of the user□s own programs and data (for example, programs and data for private use) is allowed. Programs and data for private use are stored in the memory 26 of the terminal device 12, for example.

(Process in Case where Terminal Device 12 Exists at Position D)

In the case where the terminal device 12 exists at the position D, the use of the terminal device 12 is prohibited. The processor 28 of the terminal device 12 does not start up the terminal device 12 even if an instruction for starting up the terminal device 12 is received. The processor 28 of the terminal device 12 cause the terminal device 12 to not power on, or may cause an OS installed in the terminal device 12 to not start up.

(Specific Examples of Processes)

Hereinafter, specific examples of processes according to the exemplary embodiment will be described.

The processor 28 of each terminal device 12 changes the communication destination according to the position of the terminal device 12 itself. For example, the processor 28 of each terminal device 12 connects to a communication destination corresponding to the position of the terminal device 12 itself, and restricts the use of a storage location in the terminal device 12. For example, in the case where the terminal device 12 exists at the position A, the processor 28 of the terminal device 12 connects to the server 10A and allows the user to use a program and data for the Company A. In the case where the terminal device 12 moves from the position A to the position B (for example, in the case where the user carrying the terminal device 12 moves from the position A to the position B), the processor 28 of the terminal device 12 changes the destination from the server 10A to the server 10B, connects to the server 10B without connecting to the server 10A, and allows the user to use a program and data for the Company B without allowing the user to use a program and data for the Company A. In the case where the terminal device 12 exists at the position A or the position B, the processor 28 of the terminal device 12 does not allow the user to use a storage location in the terminal device 12 itself (for example, a local folder).

In the case where the terminal device 12 moves to the position C (for example, in the case where the user carrying the terminal device 12 moves to the position C), the processor 28 of the terminal device 12 does not connect to the server 10A or 10B, does not allow the user to use a program for the Company A, data for the Company A, a program for the Company B, and data for the Company B, and allows the user to use programs and data for private use. Also, the processor 28 of the terminal device 12 allows the user to use a storage location in the terminal device 12 itself (for example, a local folder) without restrictions. One example of the position C is the user□s home. Note that the position C corresponds to an example of a specific position where connections to the servers 10A and 10B are not allowed, and the use of a storage location in the terminal device 12 itself is not restricted.

In the case where the terminal device 12 moves to the position D (for example, in the case where the user carrying the terminal device 12 moves to the position D), the processor 28 of the terminal device 12 prohibits the use of the terminal device 12. For example, the processor 28 of the terminal device 12 prohibits the startup of the terminal device 12. One example of the position D is a position where the user is prohibited from entering (such as a server room, or a place where carrying an electronic device is prohibited, for example). Note that the position D corresponds to an example of a specific position where the use of the terminal device 12 is prohibited.

The processor 28 of the terminal device 12 may prohibit the use of the terminal device 12 while the terminal device 12 is moving, or prohibit the use of the terminal device 12 in the case where the movement speed of the terminal device 12 is a threshold value or higher.

The processor 28 of the terminal device 12 may also prohibit the use of the terminal device 12 according to the positional relationship between the terminal device 12 itself and the user who uses the terminal device 12. For example, the user carries a device with a built-in GPS function, and position information about the user is acquired by the device. The processor 28 of the terminal device 12 acquires position information about the user from the device carried by the user, and prohibits the use of the terminal device 12 according to the relationship between the position indicated by the position information about the terminal device 12 itself and the position indicated by the position information about the user. For example, in the case where the distance between the terminal device 12 and the user is a threshold value or greater, the processor 28 of the terminal device 12 prohibits the use of the terminal device 12, whereas in the case where the distance is less than the threshold value, the processor 28 of the terminal device 12 allows the use of the terminal device 12. For example, in the case where the user moves away from the terminal device 12 and the distance between the user and the terminal device 12 becomes the threshold value or greater, the processor 28 of the terminal device 12 prohibits the use of the terminal device 12. In cases where the distance between the user and the terminal device 12 becomes the threshold value or greater because the user has moved away from a desk where the terminal device 12 is set up or because the user has lost the terminal device 12, the use of the terminal device 12 is prohibited. With this configuration, situations where the terminal device 12 is used by a third party other than the user may be avoided.

The processor 28 of the terminal device 12 may also control an account for which the use of the terminal device 12 is allowed according to the position of the terminal device 12 itself. The account is, for example, an account with permissions to use online services and the terminal device 12 (for example, an account for using the servers 10A and 10B and the terminal device 12) or an account with permissions to use only the terminal device 12 (for example, a local account). For example, in the case where the terminal device 12 exists at the position A, the processor 28 of the terminal device 12 allows the user to use an account with permissions to log in to the terminal device 12 and also log in to the server 10A, and in the case where the terminal device 12 exists at the position B, the processor 28 of the terminal device 12 allows the user to use an account with permissions to log in to the terminal device 12 and also log in to the server 10B. In the case where the terminal device 12 exists at the position C, the processor 28 of the terminal device 12 allows the user to use an account with permissions to log in to the terminal device 12, but does not allow the user to use an account with permissions to log into the server 10A or the server 10B. In the case where the terminal device 12 exists at the position D, the processor 28 of the terminal device 12 does not allow the user to use an account.

In the case where the terminal device 12 is connected to a communication destination corresponding to the position where the terminal device 12 exists and is executing a process, and the position of the terminal device 12 is moved away from the position corresponding to the destination, the terminal device 12 may remain connected to the destination and continue the process until the process is completed. The process may be, for example, downloading or uploading data or a program, transmitting or receiving data or a program, or a process that uses a program. Hereinafter, a specific example of the process will be described.

For example, the terminal device 12 exists at the position A, and the processor 28 of the terminal device 12 is connected to the server 10A and downloading data from the server 10A. During the download, if the position of the terminal device 12 is moved away from the position A (for example, in the case where the user carrying the terminal device 12 moves from the position A to a different position), the processor 28 of the terminal device 12 remains connected to the server 10A and continues downloading until the download is completed. When the download is completed, the processor 28 of the terminal device 12 disconnects from the server 10A and connects to a destination corresponding to the current position of the terminal device 12. The same applies to processes other than downloading. For example, in the case where the position of the terminal device 12 is moved away from the position A while the terminal device 12 is uploading data or a program, the processor 28 of the terminal device 12 remains connected to the server 10A and continues uploading until the upload is completed. Also, in the case where the position of the terminal device 12 is moved away from the position A while the processor 28 of the terminal device 12 is executing a program provided by the server 10A to execute a process, the processor 28 of the terminal device 12 continues executing the program and continues executing the process.

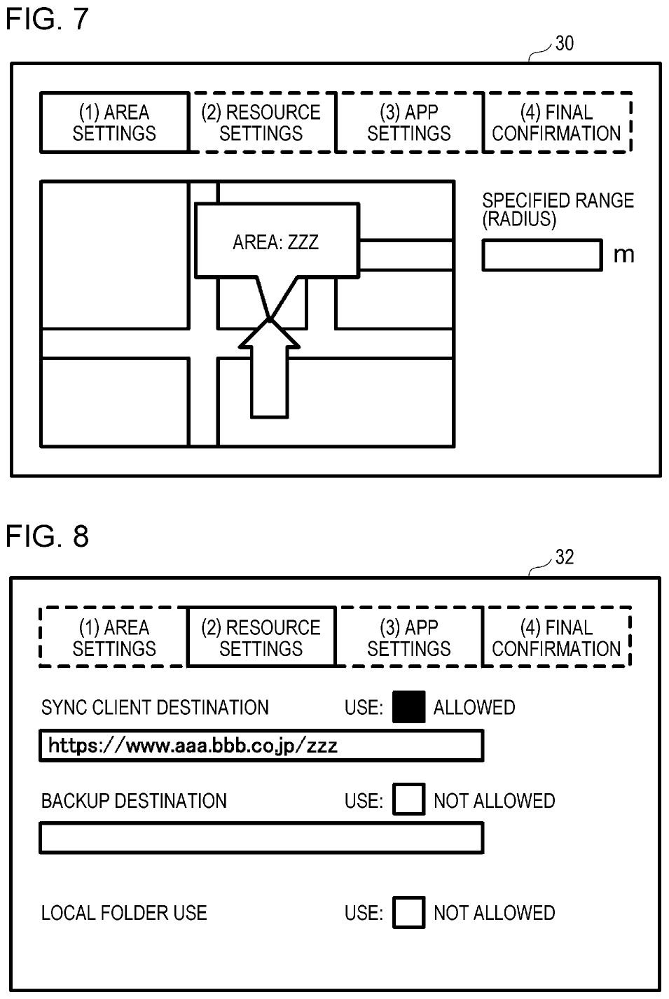

Hereinafter, FIGS. 7 to 10 will be referenced to describe settings regarding destination, storage locations allowed to be used, and programs allowed to be used. FIGS. 7 to 10 illustrate examples of settings screens. For example, a destination and the like are set by an administrator. For example, each settings screen is displayed on a display of a terminal device used by the administrator.

On a settings screen 30 illustrated in FIG. 7, an area where the setting content is to be applied is specified. For example, a map is displayed on the settings screen 30, and the administrator is able to specify the area on the map. For example, the area is specified by information such as an address, latitude and longitude, or the name of a building. Also, a specified range is specified on the settings screen 30. The specified range is a range of positions where the setting content is to be applied. Control according to the setting content is applied inside the specified range.

After the area is specified and the specified range is set on the settings screen 30, a settings screen 32 illustrated in FIG. 8 is displayed on the display of the administrators terminal device. On the settings screen 32, whether the use of destinations (for example, a sync client destination and a data backup destination) is allowed or not and also whether the use of a storage area in the terminal device 12 itself (for example, a local folder) is allowed or not are set. In the example illustrated in FIG. 8, an input field for the address (for example, the URL) of a sync client destination and an input field for the address (for example, the URL) of a backup destination are displayed on the settings screen 32, and the administrator is able to input an address into each input field. In the example illustrated in FIG. 8, an address for the sync client destination is inputted, and the use of the sync client destination is specified as allowed. An address for the backup destination is not inputted, and the use of the backup destination is specified as not allowed. Also, the use of a local folder is specified as not allowed.

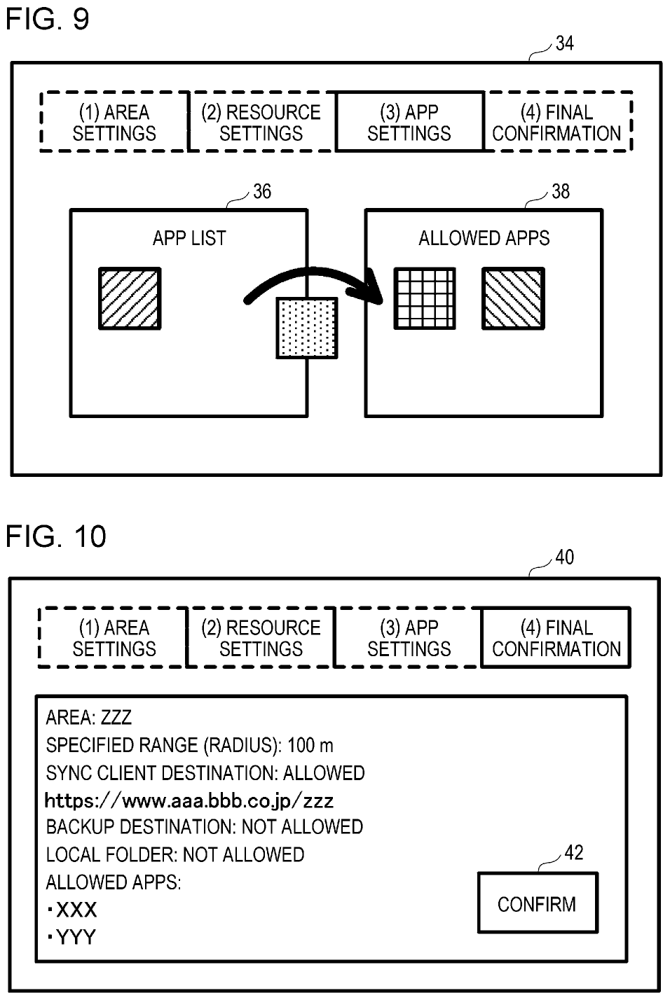

After the settings on the settings screen 32 are completed, a settings screen 34 illustrated in FIG. 9 is displayed on the display of the administrators terminal device. In the example illustrated in FIG. 9, a list 36 of application software and a list 38 of application software allowed to be used are displayed on the settings screen 34. On the list 36, the servers 10A and 10B and application software installed in the terminal device 12 are displayed. For example, the administrator selects application software that the user is allowed to use from the list 36 and moves the selected application software to the list 38, thereby allowing the user to use the selected application software. For example, if an image (for example, an icon) representing application software is moved from the list 36 to the list 38, the user is allowed to use the application software. Note that application software that the user is not allowed to use may also be selected.

After the settings regarding the application software that the user is allowed to use are completed, a settings screen 40 illustrated in FIG. 10 is displayed on the display of the administrators terminal device. The settings screen 40 is a screen used to make a final confirmation of the setting content. For example, the area “ZZZ” to which the setting content is to be applied (such as an address, latitude and longitude, or the name of a building, for example), the range (that is, the specified range) “circular range with a radius of 100 m” of the area to which the setting content is to be applied, whether the use of a sync client destination is allowed or not (in the example illustrated in FIG. 10, “allowed”), the URL that acts as the address of the sync client destination, whether the use of a backup destination is allowed or not (in the example illustrated in FIG. 10, “not allowed”), whether the use of a local folder is allowed or not (in the example illustrated in FIG. 10, “not allowed”), and application software allowed to be used are displayed on the settings screen 40. In the example illustrated in FIG. 10, the range with a radius of 100 m centered on the area “ZZZ” corresponds to one example of a position (such as the position A, for example) illustrated in FIG. 1. Note that whether the use of an account is allowed or not may also be set on the settings screen.

When a Confirm button 42 is pressed on the settings screen 40, the setting content displayed on the settings screen 40 is set in the terminal device 12 of the user. For example, usage settings information indicating the setting content is stored in the memory 26 of the terminal device 12, and the processor 28 of the terminal device 12 connects to a destination, controls the permission to use a local folder, and controls the permission to use application software according to the setting content indicated by the usage settings information. Note that the settings described with reference to FIGS. 7 to 10 may also be set on the terminal device 12 used by the user.

In the example illustrated in FIG. 10, the range with a radius of 100 m centered on the area “ZZZ” corresponds to the position A illustrated in FIG. 1. In the case where the terminal device 12 exists inside the range, the processor 28 of the terminal device 12 connects to the server 10A (for example, the URL of the sync client destination illustrated in FIG. 10). The use of a local folder in the terminal device 12 is prohibited, while the use of the application software “XXX” and “YYY” is allowed.

Note that in the case where new application software is installed in the terminal device 12 used by the user or in the case where application software installed in the terminal device 12 is uninstalled, information indicating the installation or uninstallation may be included in a notification to the administrator□s terminal device.

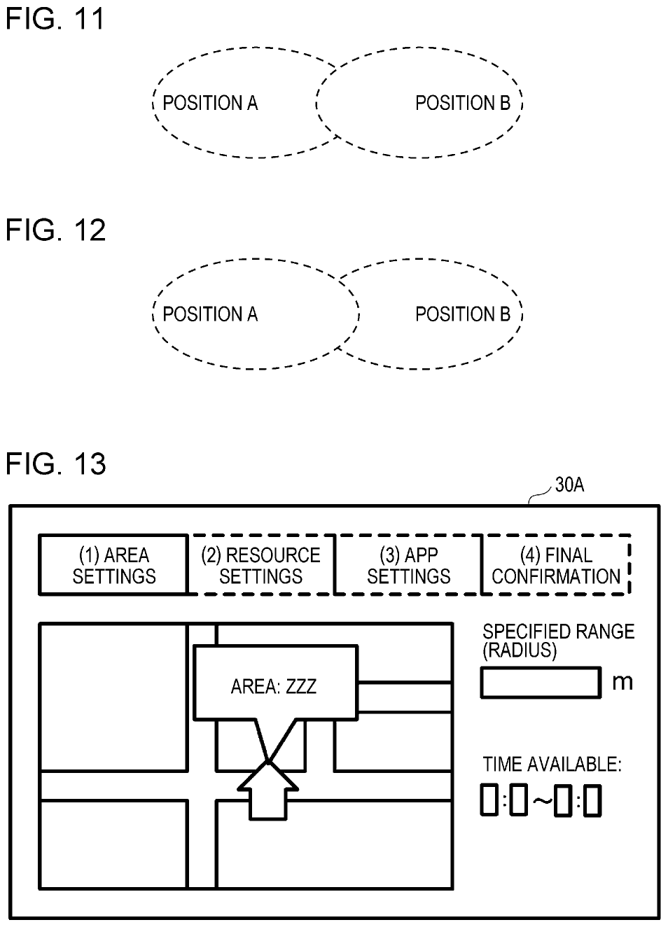

Note that the positions A, B, C, and D illustrated in FIG. 1 are set to not overlap each other. Also, in the case where different setting content is defined for the same position, the older setting content is disregarded. For example, as illustrated in FIG. 11, in the case where partially overlapping positions A and B are set according to instructions from the administrator, the setting of the position set later (for example, the position B) is disregarded, the setting of the position set earlier (for example, the position A) is disregarded, or the positions A and B are set while excluding the overlapping portion.

As a different example, in the case where the positions A and B partially overlap, the position A set earlier may be prioritized over the position B, as illustrated in FIG. 12. In this case, the setting of the position A is regarded as valid. For the setting of the position B, the portion excluding the portion that overlaps with the position A is set as the position B. In the case where the terminal device 12 exists in the overlapping position, the processor 28 of the terminal device 12 prioritizes the position A and connects to the server 10A corresponding to the position A according to the setting content corresponding to the position A. Conversely, the processor 28 of the terminal device 12 may also prioritize the position B and connect to the server 10B corresponding to the position B according to the setting content corresponding to the position B. Note that the position A corresponds to an example of a first position, the server 10A corresponds to an example of a first destination, the position B corresponds to an example of a second position, and the server 10B corresponds to an example of a second destination.

A time during which the setting content is valid may also be set. In this case, the processor 28 of the terminal device 12 connects to a destination (such as the server 10A or 10B, for example) and controls the use of a local folder in the terminal device 12 according to the setting content during the set time. Hereinafter, this process will be described in detail with reference to FIG. 13. In FIG. 13, a settings screen 30A is illustrated. On the settings screen 30A, an area and a specified range may be specified, similarly to the settings screen 30. In addition, an available use time may be specified on the settings screen 30A. Information indicating the available use time is included in the usage settings information described above. For example, if the available use time is included in the setting content illustrated in FIG. 10, at times inside the available use time, the connection to the sync client destination is allowed, the use of a local folder is not allowed, and the use of application software allowed to be used is allowed, whereas at times outside the available use time, the connection to the sync client destination is not allowed, the use of a local folder is allowed, and the use of the application software is not allowed. In this way, the usable connection, application software, and local folder are switched depending on the time, even in cases where the position of the terminal device 12 does not change. For example, in the case of using the terminal device 12 at the user□s home, the setting content is switched to the setting content for the Company A (that is, the position A) from 9:00 am to 5:30 pm, and is switched to setting content for private use by the user at all other times.

The available use time described above may also be set automatically in cooperation with a schedule function that manages the user□s schedule. Also, in the case where the position of the user is managed by the schedule function, a destination corresponding to the position may also be set.

The switching of the destination and application software may also be performed in units of a communication technology such as 4G, 5G, 6G, Wi-Fi, LoRa, or BLE. For example, 4G is used for communication with the server 10A, and 5G is used for communication with the server 10B. In this way, different communication technologies may be used according to the position. Also, communication encryption technology may be switched according to the position. Also, the frequency of data backup may be changed according to the position.

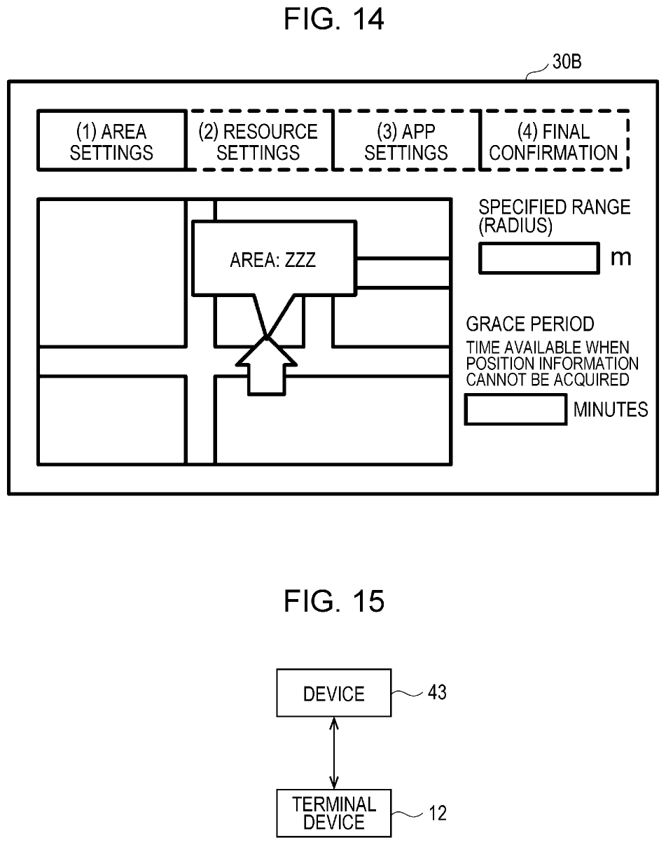

A grace period until a connection to a destination corresponding to a position becomes unavailable may also be set. In this case, the processor 28 of the terminal device 12 connects to the destination corresponding to the position during the grace period. For example, in the case where position information about the terminal device 12 is not acquired successfully, the connection to the destination corresponding to the position is not disconnected immediately, nor is the use of application software corresponding to the position prohibited immediately. Instead, a grace period until the disconnection and prohibition is set, and for the duration of the grace period, the connection to the destination is allowed and the use of the application software is allowed. Hereinafter, this process will be described in detail with reference to FIG. 14. In FIG. 14, a settings screen 30B is illustrated. On the settings screen 30B, an area and a specified range may be specified, similarly to the settings screen 30. In addition, a grace period may be specified on the settings screen 30B. Information indicating the grace period is included in the usage settings information described above. For example, if the grace period is included in the setting content illustrated in FIG. 10, if position information about the terminal device 12 is no longer acquired while the processor 28 of the terminal device 12 is connected to a sync client destination included in the setting content, the connection to the sync client destination is allowed for the duration of the grace period starting from the time point when the position information was no longer acquired. Also, the use of the application software allowed to be used is allowed for the duration of the grace period. The grace period may be set for each position (for each of the positions A and B, for example).

Hereinafter, exemplary modifications of the exemplary embodiment will be described.

In the case where the same user uses multiple terminal devices 12 (for example, in the case where the same user uses the same account to log in to multiple terminal devices 12), the processor 28 of each terminal device 12 may prohibit pairing between the multiple terminal devices 12. For example, the processor 28 of each terminal device 12 may prohibit the execution of a pairing function, or prohibit the installation of a program that uses pairing.

As illustrated in FIG. 15, a device 43 in which electronic key application software is installed and the terminal device 12 may cooperate with each other. For example, the electronic key application software corresponds to a position (for example, the position A), and in the case where the terminal device 12 exists at the position A, the processor 28 of the terminal device 12 cooperates with the device 43 to allow the use of the electronic key application software. In the case where the terminal device 12 does not exist at the position A or in the case where position information about the terminal device 12 is not acquired, the processor 28 of the terminal device 12 does not allow the use of the electronic key application software. With this configuration, even in the case where the device 43 is lost, it is possible to keep the electronic key application software installed in the device 43 from being used without the terminal device 12.

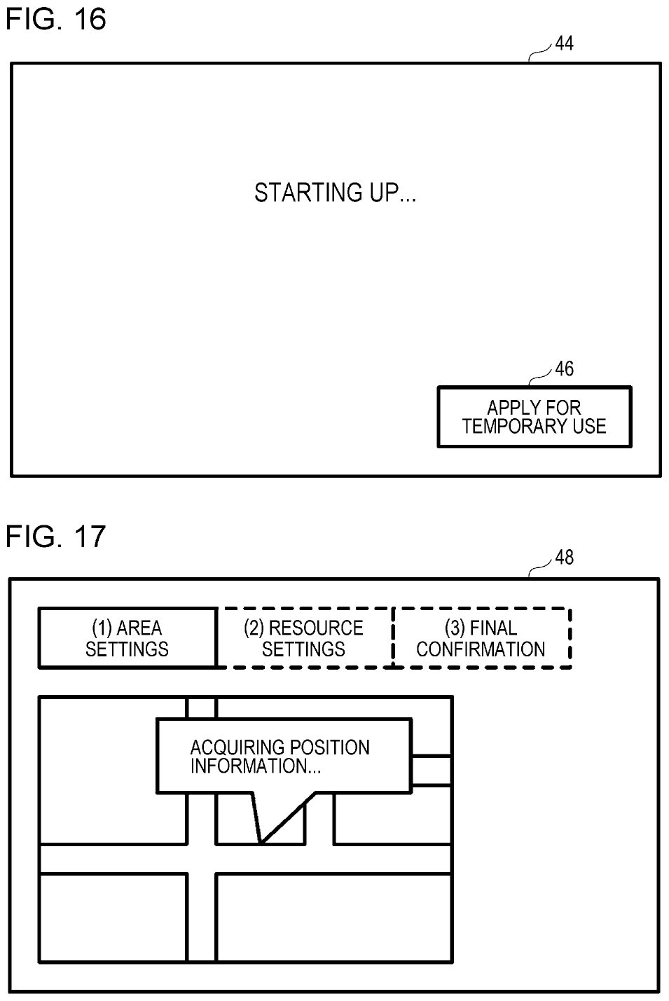

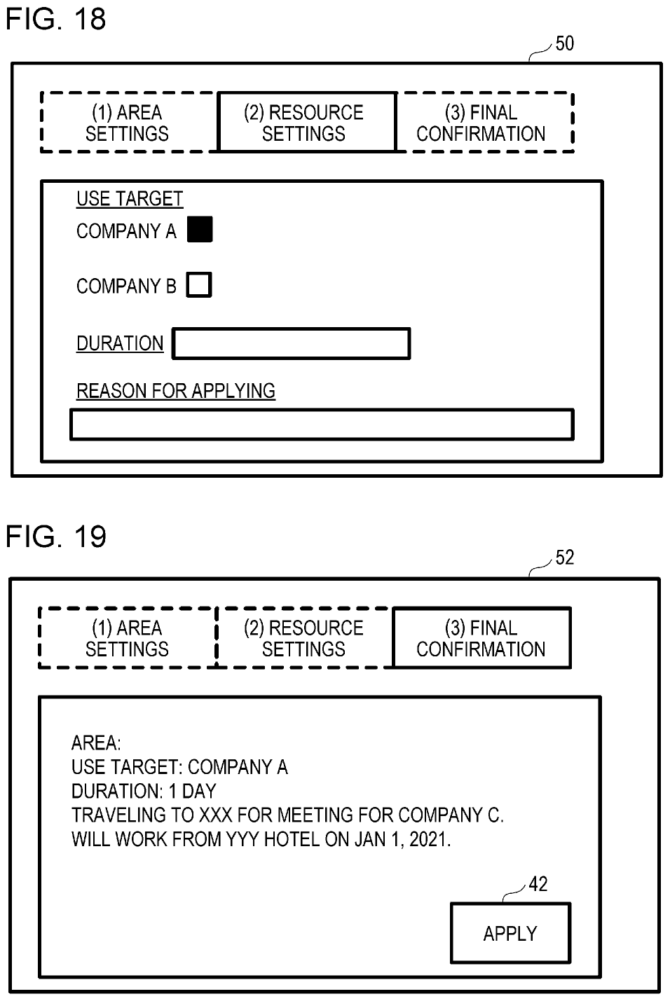

The use of a destination or the like may also be allowed temporarily. For example, the use of a destination or the like may be allowed temporarily at the location of a business trip or visit (such as a hotel or company, for example), or the use of a destination or the like may be allowed temporarily when an incident such as an accident occurs. Hereinafter, this process will be described with reference to FIGS. 16 to 19. In FIG. 16, a screen 44 displayed when starting up the terminal device 12 is illustrated. On the screen 44, a button 46 for applying for temporary use is displayed. When the button 46 is pressed, the processor 28 of the terminal device 12 executes a process of applying for temporary use. When the button 46 is pressed, a settings screen 48 illustrated in FIG. 17 is displayed on the display of the terminal device 12. For example, the processor 28 of the terminal device 12 acquires position information about the terminal device 12, and information indicating that the position information is being acquired is displayed on the settings screen 48. Next, an application screen 50 illustrated in FIG. 18 is displayed on the display of the terminal device 12. On the application screen 50, a use target, a use period, and a reason for applying may be inputted. The use target may be specified by a company name such as Company A or Company B, and may also be specified by a position such as the position A corresponding to the Company A or the position B corresponding to the Company B, for example. The use period is the duration for which the destination or the like is to be used temporarily. The reason for applying is the reason why the destination or the like is to be used temporarily. When each piece of information is inputted into the application screen 50, a settings screen 52 illustrated in FIG. 19 is displayed on the display of the terminal device 12. The settings screen 52 is a final confirmation screen, and each piece of information that was inputted into the application screen 50 is displayed for confirmation by the user. An Apply button 54 is displayed on the settings screen 52. If the Apply button 54 is pressed by the user, the processor 28 of the terminal device 12 transmits information indicating the content specified on the application screen 50 to the administrators terminal device or to a device that approves or denies the application. For example, in the case where temporary use is approved by the administrator, information indicating the approval is transmitted from the administrators terminal device to the terminal device 12. In this case, the processor 28 of the terminal device 12 connects to the destination (for example, the server 10A corresponding to the position A) and allows the user to use the application software allowed to be used at the position A according to the content set on the application screen 50.

The function of each unit in the servers 10A and 10B and the terminal device 12 above is realized by the cooperative action of hardware and software as an example. For example, the functions of each device are achieved by causing a processor in each device to load and execute a program stored in a memory of each device. The program is stored in the memory through a recording medium such as a CD or DVD, or alternatively through a communication channel such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to:
control a connection to a communication destination and use of a data storage location in the information processing device itself on a basis of a position of the information processing device.

2. The information processing device according to claim 1, wherein
the processor is configured to:
connect to a communication destination corresponding to the position; and
restrict the use of the storage location.

3. The information processing device according to claim 2, wherein
the restriction of the use of the storage location prohibits the use of the storage location.

4. The information processing device according to claim 1, wherein
in a case where the information processing device exists at a specific position, the processor is configured to:
not connect to a communication destination corresponding to the position; and
not restrict the use of the storage location.

5. The information processing device according to claim 2, wherein
in a case where the information processing device exists at a specific position, the processor is configured to:
not connect to a communication destination corresponding to the position; and
not restrict the use of the storage location.

6. The information processing device according to claim 3, wherein
in a case where the information processing device exists at a specific position, the processor is configured to:
not connect to a communication destination corresponding to the position; and
not restrict the use of the storage location.

7. The information processing device according to claim 1, wherein
in a case where the information processing device exists at a specific position, the processor is further configured to:
prohibit use of the information processing device itself.

8. The information processing device according to claim 2, wherein
in a case where the information processing device exists at a specific position, the processor is further configured to:
prohibit use of the information processing device itself.

9. The information processing device according to claim 3, wherein
in a case where the information processing device exists at a specific position, the processor is further configured to:
prohibit use of the information processing device itself.

10. The information processing device according to claim 1, wherein
the processor is further configured to:
prohibit the use of the information processing device itself according to a positional relationship between a user who uses the information processing device and the information processing device itself.

11. The information processing device according to claim 2, wherein
the processor is further configured to:
prohibit the use of the information processing device itself according to a positional relationship between a user who uses the information processing device and the information processing device itself.

12. The information processing device according to claim 1, wherein
the processor is further configured to:
change a program available for use on the information processing device according to the position.

13. The information processing device according to claim 12, wherein
the processor is configured to:
allow the use of a program corresponding to the position.

14. The information processing device according to claim 1, wherein
the processor is further configured to:
control an account allowed to be used on the information processing device according to the position.

15. The information processing device according to claim 1, wherein
in a case where the information processing device is connected to a communication destination corresponding to the position and is executing a process, and the position of the information processing device is moved away from the position corresponding to the communication destination, the processor is configured to:
remain connected to the destination and continue the process until the process is completed.

16. The information processing device according to claim 1, wherein
in a case where a first position corresponding to a first destination and a second position corresponding to a second destination overlap partially, and the information processing device exists at the overlapping position, the processor is further configured to:
connect to only one of the first destination or the second destination.

17. The information processing device according to claim 1, wherein
a time during which a connection to the destination is available is set, and
the processor is configured to:
connect to the destination during the set time.

18. The information processing device according to claim 1, wherein
a grace period until a connection to a communication destination corresponding to the position becomes unavailable is set, and
the processor is configured to:
connect to the communication destination corresponding to the position during the grace period.

19. An information processing method comprising:
controlling a connection to a communication destination by a device and use of a data storage location in the device itself on a basis of a position of the device.

20. A non-transitory computer readable medium storing a program causing a computer to execute a process comprising:
controlling a connection to a communication destination by a device and use of a data storage location in the device itself on a basis of a position of the device.
